(19) United States
(12) Patent Application Publication
(10) Pub. No.: US 2025/0160346 A1
(43) Pub. Date: May 22, 2025

(54) KNEECAP HARVESTER AND METHOD FOR REMOVING A KNEECAP

(71) Applicant: Meyn Food Processing Technology B.V., OOSTZAAN (NL)

(72) Inventor: Eric Adriaan van Hillo, Oostzaan (NL)

(21) Appl. No.: 18/951,746

(22) Filed: Nov. 19, 2024

(30) Foreign Application Priority Data
Nov. 20, 2023 (NL) 2036312

(51) Int. Cl. A22C 21/00

(52) U.S. Cl. CPC A22C 21/0076; A22C 21/0046

(57) ABSTRACT

Method and apparatus for removing a kneecap from a thighbone, the kneecap to which at least a portion of kneemeat attaches. A forward end of a chisel engages the thighbone and is subsequently moved between the thighbone and the kneecap so as to detach at least part of the naturally present connections between the thighbone and the kneecap.

### PRIORITY STATEMENT

The present application claims priority under 35 U.S.C § 119 to Dutch Patent Application No. 2036312, filed on Nov. 20, 2023.

### FIELD OF THE INVENTION

The subject matter of the present disclosure relates generally to a kneecap harvester and to a method for removing a kneecap from a thighbone to which kneecap at least a portion of kneemeat attaches.

WO2015/194945 discloses a method and a corresponding system for harvesting kneemeat and thighmeat from a whole leg poultry product. The method includes providing a leg product having a thigh, a drumstick, and a knee; bringing a knee cap scraper in engagement with the leg product adjacent to the knee cap and a counter element at the rear of the knee cap; moving the knee cap past the knee cap scraper while the counter element engages the leg product at the rear of the knee cap, therewith scraping kneemeat from the kneecap while leaving the kneemeat connected to the thigh.

As an option WO2015/194945 discloses severing the scraped kneecap from the drumstick by cutting at a first cutting location which is situated between the kneecap and the drumstick, or severing the kneecap from the thigh and the knee meat by cutting at a second cutting location which is situated between the kneecap and the thigh, adjacent to the kneecap scraper, during which severing the knee meat and the thigh remain interconnected.

All embodiments that are explicitly disclosed by WO2015/194945 show how to perform the optional harvesting of the kneecap when the thighbone is already removed from the thigh, whilst the drumstick still attaches to the thigh. There is therefore no clear and unambiguous teaching in WO2015/194945 how to harvest the kneecap when beside the thigh meat, also the thighbone is still present in the thigh, nor does it teach how to harvest the kneecap when the thigh is already completely separated from the drumstick.

EP 2 866 573 B1 and WO 2008/087617 discloses other methods and devices for removing the kneecap from a poultry leg, although also in EP 2 866 573 B1 the kneecap is removed after removal of the thighbone.

U.S. Pat. No. 3,486,187 discloses with reference to its FIGS. 21 through 24, still another method and means for removing the kneecap or patella from an animal leg. U.S. Pat. No. 3,486,187 shows a patella remover having a blade holder which slidably engages a pointed blade. The blade is positioned adjacent the patella of the animal and is sharpened at the edges so that it can penetrate the flesh adjacent to the patella. An exciser having a sharpened edge is supported for rotation relative to the blade holder. As the exciser rotates relative to the blade holder to remove the patella, the blade retracts within the holder so that the exciser can cut behind the patella and shear off the tendons supporting it between the exciser and the blade holder.

### SUMMARY OF THE INVENTION

In certain exemplary aspects, it is an object of the invention to teach how to provide an improved method of how to harvest the kneecap in different circumstances, as well as an improved kneecap harvester. These and other objectives that may become apparent from the following disclosure are realized with a method and kneecap harvester according to one or more of the appended claims.

According to an exemplary method of the invention, a forward end of a chisel may engage the thighbone and is subsequently moved between the thighbone and the kneecap so as to detach at least part of the naturally present connections between the thighbone and the kneecap. During the execution of the method, the thighbone is clamped into a fixed position. In an exemplary aspect, this method step can be applied when the drum bone is already completely separated from the thigh but also when the drum bone still attaches to the thighbone. In the present application the wording drum bone also englobes the possibility that it still contains its drum meat.

Particularly when the drum bone is already separated from the thighbone, in one exemplary aspect the motion of the chisel between the thighbone and the kneecap is followed by moving the chisel with the kneecap away from the thighbone. In another exemplary aspect, at the kneecap facing end of the thighbone a support plate is provided to restrict motion of the thighbone whilst the chisel engages the thighbone. As the chisel moves with the kneecap away from the thighbone, it is then advantageous that the chisel slides along the support plate.

In one exemplary aspect, when the method of the invention is applied while a drum bone still attaches to the thighbone, a gripper may fix the drum bone with the thighbone attached thereto in position.

Particularly when a drum bone still attaches to the thighbone, in another exemplary aspect a blade or blades may engage the meat in the vicinity of the kneecap so as to release all connections of the kneecap with the thighbone and drum bone.

In certain exemplary methods of the invention, a kneecap harvester may be provided with the feature that the harvester includes a movable chisel with a forward end arranged to engage a thighbone and to move between the thighbone and the kneecap so as to detach at least part of the naturally present connections between the thighbone and the kneecap, wherein the harvester may include a clamp or clamps for fixing the thighbone in position before the chisel engages the thighbone. This feature can be particularly beneficial when the drum bone has already been removed from the thighbone, although this is not essential.

Suitably the chisel may be arranged to move the kneecap away from the thighbone after detaching at least part of the naturally present connections between the thighbone and the kneecap.

In certain exemplary aspects, the forward end of the chisel may be indented to better adapt to the curvature of the thighbone. In other aspects, the harvester may be provided with a support plate to restrict motion of the thighbone whilst the chisel engages the thighbone.

For operating on a poultry leg including a drum bone and thighbone, the harvester may include a gripper for securing the drum bone which is attached to the thighbone into a fixed position.

The harvester may include a blade or blades to engage the meat in the vicinity of the kneecap so as to release all connections of the kneecap with the thighbone and/or drum bone.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

The accompanying drawings, which are incorporated into and forms a part of the specification, illustrates one or more embodiments of the present invention and, together with the description, serves to explain the principles of the invention. The drawings are only for the purpose of illustrating one or more embodiments of the invention and is not to be construed as limiting the invention.

FIG. 1 shows a first exemplary embodiment of an apparatus of the invention in a side view for processing a thighbone that is still connected to the drumstick;

FIG. 2 shows the exemplary apparatus of FIG. 1 in a further step of processing the thighbone;

FIG. 3 shows the apparatus of FIG. 1 in still a further processing step;

FIG. 4 shows a second exemplary embodiment of an apparatus of the invention in a side view for processing a thighbone that is completely separated from the drumstick;

FIG. 5 shows the apparatus of FIG. 4 in a further step of processing the thighbone;

FIG. 6 shows the apparatus of FIG. 4 in still a further processing step; and

FIG. 7 shows in detail a front view of a chisel used in the above-mentioned figures.

Whenever in the drawings the same reference numerals are applied, these numerals refer to the same parts.

### DETAILED DESCRIPTION OF THE INVENTION

For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

Common to the shown exemplary embodiments of an apparatus of the invention as depicted in FIG. 1 and FIG. 4, respectively is that a forward beveled end 2 of a chisel 1 engages the thighbone 3. In these embodiments the thighbone 3 is shown without the thigh meat which has already been removed from the thighbone 3.

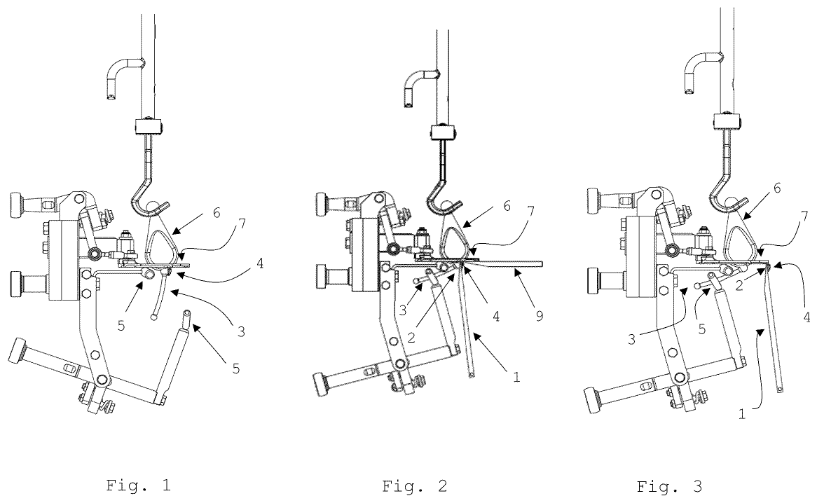

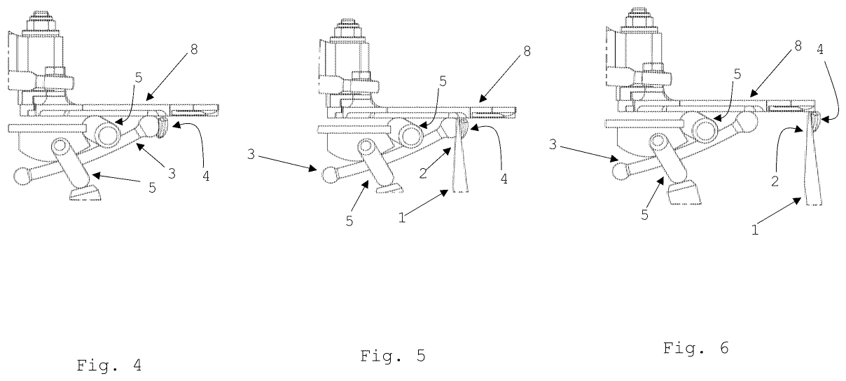

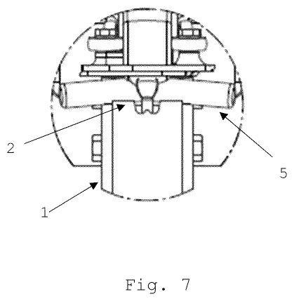

After the chisel 1 has engaged the thighbone 3 as shown in FIGS. 2 and 5 for the two respectively shown embodiments, the chisel 1 is moved between the thighbone 3 and the kneecap 4 so as to detach at least part of the naturally present connections between the thighbone 3 and the kneecap 4. This applies to both embodiments of FIGS. 1 and 4.

In the first exemplary embodiment of FIGS. 1-3, a gripper 7 fixes the drumstick 6 with the thighbone 3 attached thereto in position.

FIGS. 4-6 relate to the exemplary embodiment wherein the thighbone 3 is completely separated from the drumstick, for example after a blade (not shown) is activated after the thigh bone is grabbed by the gripper 7 as in the embodiment of FIG. 2. FIGS. 5 and 6 show that the motion of the chisel 1 between the thighbone 3 and the kneecap 4 is followed by moving the chisel 1 with the kneecap 4 away from the thighbone 3. It further shows that the thighbone 3 is clamped into a fixed position by clamps 5.

FIGS. 4-6 also show that at the kneecap facing end of the thighbone 3 a support plate 8 can be provided to restrict motion of the thighbone 3 whilst the chisel 1 engages the thighbone 3. The gripper 7 used in the first embodiment may be used for that.

Further FIG. 5 and FIG. 6 show that as the chisel 1 moves with the kneecap 4 away from the thighbone 3, the chisel 1 slides along the support plate 8. This makes removing of the kneecap 4 with the attaching meat a reliable and repeatable operation.

In the embodiment of FIGS. 1-3 wherein a drum bone 6 still attaches to the thighbone 3, FIG. 2 shows that a blade 9 or blades engage the meat in the vicinity of the kneecap 4 so as to release all connections of the kneecap 4 with the thighbone 3 and drum bone 6. It is also possible that the harvester of the second exemplary embodiment of FIGS. 4-6 includes a blade or blades 9 to engage the meat in the vicinity of the kneecap 4 so as to release all connections of the kneecap 4 with the thighbone 3 and/or drum bone 6. Also, the beveled forward end may have a cutting edge.

Accordingly, in an exemplary embodiment, the invention can be embodied in a kneecap harvester as schematically depicted in the drawings, wherein the harvester can include a movable chisel 1 with a beveled forward end 2 to engage a thighbone 3 and to move between the thighbone 3 and the kneecap 4 so as to detach at least part of the naturally present connections between the thighbone 3 and the kneecap 4.

Finally, FIG. 7 depicts a front view of the chisel 1 that has been used in the above-mentioned embodiments. The forward 2 end of chisel 1 is indented for this exemplary embodiment.

Embodiments of the present invention can include every combination of features that are disclosed herein independently from each other. Although the invention has been discussed in the foregoing with reference to exemplary embodiments of the invention, the invention is not restricted to these particular embodiments which can be varied in many ways without departing from the invention. The discussed exemplary embodiments shall therefore not be used to construe the appended claims strictly in accordance therewith. On the contrary the embodiments are merely intended to explain the wording of the appended claims without intent to limit the claims to these exemplary embodiments. The scope of protection of the invention shall therefore be construed in accordance with the appended claims only, wherein a possible ambiguity in the wording of the claims shall be resolved using these exemplary embodiments.

Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

1-12. (canceled)

13. A method for removing a kneecap from a thighbone to which kneecap at least a portion of kneemeat attaches, comprising:
clamping the thighbone into a fixed position;
engaging the thighbone with a forward end of a chisel;
moving the chisel between the thighbone and the kneecap; and
detaching at least part of naturally present connections between the thighbone and the kneecap.

14. The method according to claim 13, further comprising moving the chisel with the kneecap away from the thighbone after moving the chisel between the thighbone and the kneecap.

15. The method according to claim 13, further comprising providing a support plate at the kneecap facing end of the thighbone to restrict motion of the thighbone while the chisel engages the thighbone.

16. The method according to claim 15, sliding the chisel along the support plate as the chisel moves with the kneecap away from the thighbone.

17. The method according to claim 13, wherein a drum bone attaches to the thighbone, further comprising using a gripper to fix into position the drum bone with the thighbone attached thereto.

18. The method according to claim 13, further comprising engaging the meat in the vicinity of the kneecap with one or more blades so as to release all connections of the kneecap with the thighbone and the drum bone.

19. A kneecap harvester for removing a kneecap from a poultry thighbone, comprising:
a movable chisel with a forward end arranged to engage a thighbone and to move between the thighbone and the kneecap so as to detach at least part of the naturally present connections between the thighbone and the kneecap; and
at least one clamp for fixing the thighbone in position prior to the chisel engaging the thighbone.

20. The kneecap harvester of claim 19, wherein the chisel is arranged to move the kneecap away from the thighbone after detaching at least part of the naturally present connections between the thighbone and the kneecap.

21. The kneecap harvester of claim 19, wherein the forward end of the chisel is indented.

22. The kneecap harvester of claim 19, further comprising a support plate to restrict motion of the thighbone while the chisel engages the thighbone.

23. The kneecap harvester of claim 19, further comprising a gripper for securing a drum bone which is attached to the thighbone into a fixed position.

24. The kneecap harvester of claim 19, further comprising at least one blade to engage the meat in the vicinity of the kneecap so as to release all connections of the kneecap with the thighbone, the drum bone, or both.
